(19) United States
(12) Patent Application Publication
(10) Pub. No.: US 2026/0238067 A1
(43) Pub. Date: Aug. 13, 2026

(54) MOTOR AND PUMP COMPRISING SAME

(71) Applicant: LG INNOTEK CO., LTD., Seoul (KR)

(72) Inventors: Hoon Ki HONG, Seoul (KR); Moon Jae LEE, Seoul (KR)

(21) Appl. No.: 19/130,487

(22) PCT Filed: Nov. 14, 2023
(86) PCT No.: PCT/KR2023/018226

§ 371 Date: May 15, 2025

(30) Foreign Application Priority Data
Nov. 15, 2022 (KR) 10-2022-0152656
Nov. 25, 2022 (KR) 10-2022-0160586
Nov. 25, 2022 (KR) 10-2022-0160587

(51) Int. Cl. H02K 5/15; F04C 2/08; F04C 15/00; H02K 7/08; H02K 7/116; H02K 21/14

(52) U.S. Cl. CPC H02K 5/15; F04C 2/084; F04C 15/008; H02K 7/085; H02K 7/116; H02K 21/14; F04C 2240/40; F04C 2240/60

(57) ABSTRACT

The present invention can provide a motor which includes a shaft, a rotor coupled to the shaft, a stator disposed to correspond to the rotor, a plate coupled to the rotor, a first bearing and a second bearing which support the plate, and a can accommodating the rotor, wherein the rotor includes a rotor core and a magnet disposed on the rotor core, the shaft includes a hole, the plate includes a body disposed at one side of the rotor, a first column protruding from the body toward one side in an axial direction and disposed in the hole and a second column protruding toward the other side in the axial direction, the first bearing is in contact with an inner wall of the hole and the first column, and the second bearing is in contact with an inner wall of the can and the second column.

### CROSS-REFERENCE TO RELATED APPLICATIONS

This application is the U.S. national stage application of International Patent Application No. PCT/KR2023/018226, filed Nov. 14, 2023, which claims the benefit under 35 U.S.C. § 119 of Korean Application Nos. 10-2022-0152656, filed Nov. 15, 2022; 10-2022-0160586, filed Nov. 25, 2022; and 10-2022-0160587, filed Nov. 25, 2022; the disclosures of each of which are incorporated herein by reference in their entirety.

### TECHNICAL FIELD

The present invention relates to a motor and a pump including the same.

### BACKGROUND ART

Generally, in a motor, a rotor is rotated by electromagnetic interactions between the rotor, and a stator. In this case, the shaft connected to the rotor is also rotated to generate a rotational driving force.

A pump including a motor may include an outer gear and an inner gear in a can as a rotor. A shaft is disposed inside the inner gear. The inner gear is rotatably coupled to the shaft. A magnet may be disposed on an outer surface of the outer gear. The magnet is disposed to face a stator with the can interposed therebetween.

The can and the outer gear are rotated about the shaft by an electric interaction between the magnet and the stator, and the inner gear is rotated about the shaft in conjunction with the outer gear.

A bearing is disposed between the outer gear and the shaft. The outer gear is rotatably supported by the bearing. However, since the bearing is disposed at only one side of the outer gear in an axial direction, the outer gear may tilt due to a tolerance of the bearing in the axial direction.

When the outer gear tilts in the axial direction due to the tolerance of the bearing, an outer circumferential portion of the magnet or the outer surface of the outer gear comes into contact with an inner wall of the can to increase frictional resistance, and thus there is a problem that the rotational stability of the outer gear or the inner gear is degraded.

The can and the outer gear are rotated about the shaft by the electric interaction between the magnet and the stator, and the inner gear is rotated about the shaft in conjunction with the outer gear.

A load is applied to the outer gear and the inner gear in a radial direction due to a magnetic force and a hydraulic pressure. When the load increases at the pump, the load is concentrated on a partial region of a plate at one side of the rotor, and the outer gear is tilted in the axial direction. When a shaft system tilts as described above, the outer circumferential portion of the magnet or the outer surface of the outer gear comes into contact with the inner wall of the can to increase a frictional force, and thus there is a problem that the rotational stability of the outer gear or the inner gear is degraded.

The outer gear may be coupled to the plate, and the plate may be rotatably supported by the shaft through the bearing. However, since the bearing is disposed at only one side of the outer gear in the axial direction, when a high hydraulic pressure is generated in the can, there is a problem that the shaft system tilts.

When the shaft system tilts, the outer gear tilts in the axial direction, the outer circumferential portion of the magnet or the outer surface of the outer gear comes into contact with the inner wall of the can to increase the frictional resistance, and thus there are problems that the rotational stability of the outer gear or the inner gear is degraded, and the efficiency of the pump is rapidly reduced.

### Technical Problem

The present invention is intended to solve the above-described problems and directed to providing a motor in which the resistances of an outer gear and an inner gear capable are reduced and the outer gear and the inner gear are inhibited from tilting to secure rotational stability, and a pump including the same.

Objects of the present invention are not limited to the above-described object, and other objects that have not been described above will be clearly understood by those skilled in the art through the following descriptions.

### Technical Solution

One aspect of the present invention provides a motor which includes a shaft, a rotor coupled to the shaft, a stator disposed to correspond to the rotor, a plate coupled to the rotor, a first bearing and a second bearing which support the plate, and a can accommodating the rotor, wherein the rotor includes a rotor core and a magnet disposed on the rotor core, the shaft includes a hole, the plate includes a body disposed at one side of the rotor, a first column protruding from the body toward one side in an axial direction and disposed in the hole and a second column protruding toward the other side in the axial direction, the first bearing is in contact with an inner wall of the hole and the first column, and the second bearing is in contact with an inner wall of the can and the second column.

Another aspect of the present invention provides a pump which includes a can, a stator disposed outside the can, an outer gear disposed in the can, an inner gear disposed inside the outer gear, a shaft disposed inside the inner gear, a plate coupled to the shaft, and a first bearing and a second bearing which support the plate, wherein the shaft includes a hole, and the plate includes a body disposed at one side of the outer gear, a first column protruding from the body toward one side in an axial direction and disposed in the hole, and a second column protruding toward the other side in the axial direction, the first bearing is in contact with an inner wall of the hole and the first column, and the second bearing is in contact with an inner wall of the can and the second column.

### Advantageous Effects

According to embodiments, since a motor includes a first bearing and a second bearing which respectively supports a first column and a second column disposed on a plate, an outer gear and an inner gear are inhibited from tilting with respect to a reference an axial direction, and thus there are advantages of improving the rotational stability of a rotor is improved and reducing the torque loss caused by friction with a can.

According to embodiments, since a second bearing is pressed in advance using an elastic member disposed between a can and the second bearing in an axial direction, an outer gear is inhibited from being tilted due to a tolerance of the second bearing, and thus there is an advantage of more efficiently improving the rotational stability of a rotor.

According to embodiments, since a first bearing is mounted inside a hole using the hole of a shaft, both one side and the outer side of a rotor are rotatably supported in a limited space, there is an advantage of further improving the rotational stability of the rotor.

According to embodiments, since a plate is directly fixed to a shaft with a can using a fastening member, the plate is inhibited from tilting, and thus there is an advantage of inhibiting a shaft system from tilting.

According to embodiments, since shaking of a plate is minimized, there is an advantage that a tolerance between a rotor and the plate can be precisely managed.

According to embodiments, since a plate is directly fixed using a fastening member, the plate can be inhibited from rotating.

According to embodiments, since a bearing is installed in a first shaft and the bearing is formed to rotatably support both end portions of a second shaft connected to a plate, a shaft system is inhibited from tilting, and thus there is an advantage of reducing frictional resistance to improve efficiency.

According to embodiments, since a bearing is formed to support both one side and the other side of a second shaft based on a center of a rotor in an axial direction, there is an advantage of effectively inhibiting a shaft system from tilting.

According to embodiments, since a bearing, of which both ends support both ends of a second shaft and are disposed to be spaced apart from an inner circumferential surface of a first shaft, is easily assembled in the first shaft, and a central portion of the bearing is spaced apart from the second shaft, contactability at both end portions of the second shaft is improved to more effectively inhibit a shaft system from tilting.

### DESCRIPTION OF DRAWINGS

FIG. 1 is a cross-sectional view illustrating a pump according to an embodiment.

FIG. 2 is an exploded view illustrating the pump illustrated in FIG. 1.

FIG. 3 is a view illustrating an outer gear, an inner gear, and a cover illustrated in FIG. 1.

FIG. 4 is a plan view illustrating the cover and a shaft.

FIG. 5 is an exploded view illustrating the outer gear and a magnet.

FIG. 6 is a perspective view illustrating the outer gear and the magnet.

FIG. 7 is a perspective view illustrating the outer gear including a first surface and a second surface.

FIG. 8 is a transversal sectional view illustrating the outer gear along line A-A of FIG. 7.

FIG. 9 is a perspective view illustrating a plate.

FIG. 10 is a transversal sectional view illustrating the plate along line B-B of FIG. 9.

FIGS. 11 to 13 are enlarged transversal sectional views illustrating the pump.

FIG. 14 is a cross-sectional view illustrating a pump according to an embodiment.

FIG. 15 is an exploded view illustrating the pump illustrated in FIG. 14.

FIG. 16 is a view illustrating an outer gear, an inner gear, and a cover illustrated in FIG. 14.

FIG. 17 is a plan view illustrating the cover and a shaft.

FIG. 18 is an exploded view illustrating the outer gear and a magnet.

FIG. 19 is a perspective view illustrating the outer gear and the magnet.

FIG. 20 is a perspective view illustrating a plate.

FIG. 21 is a bottom view illustrating the plate.

FIG. 22 is a transversal sectional view illustrating the shaft.

FIG. 23 is a view illustrating a can and a fastening member.

FIG. 24 is a transversal sectional view illustrating the pump.

FIG. 25 is a cross-sectional view illustrating a pump according to an embodiment.

FIG. 26 is an exploded view illustrating the pump illustrated in FIG. 25.

FIG. 27 is a view illustrating an outer gear, an inner gear, and a cover illustrated in FIG. 26.

FIG. 28 is a plan view illustrating the cover and a shaft.

FIG. 29 is an exploded view illustrating the outer gear and a magnet.

FIG. 30 is a perspective view illustrating the outer gear and the magnet.

FIG. 31 is a perspective view illustrating the outer gear including a first surface and a second surface.

FIG. 32 is a transversal sectional view illustrating the outer gear along line A-A of FIG. 31.

FIG. 33 is a perspective view illustrating a plate.

FIG. 34 is a transversal sectional view illustrating the plate along line B-B of FIG. 33.

FIG. 35 is a transversal sectional view illustrating a first shaft.

FIG. 36 is a view illustrating a second shaft and a snap ring.

FIG. 37 is a transversal sectional view illustrating a bearing.

FIG. 38 is a transversal sectional view illustrating a rotor.

### MODES OF THE INVENTION

Hereinafter, exemplary embodiments of the present invention will be described in detail with reference to the accompanying drawings.

However, the technical spirit of the present invention is not limited to some embodiments which will be described and may be implemented in a variety of different forms, and one or more components of the embodiments may be selectively combined, substituted, and used within the range of the technical spirit of the present invention.

In addition, unless clearly and specifically defined otherwise by the context, all terms (including technical and scientific terms) used herein can be interpreted as having meanings customarily understood by those skilled in the art, and the meanings of generally used terms, such as those defined in commonly used dictionaries, will be interpreted in consideration of contextual meanings of the related art.

In addition, terms used in the embodiments of the present invention are considered in a descriptive sense only and not to limit the present invention.

In the present specification, unless specifically indicated otherwise by the context, singular forms include plural forms, and in a case in which “at least one (or one or more) among A, B, and C” is described, this may include at least one combination among all possible combinations of A, B, and C.

In addition, in descriptions of components of the present invention, the terms such as “first,” “second,” “A,” “B,” “(a),” and “(b)” may be used.

Terms are only to distinguish one component from another component, and the essence, order, and the like of the components are not limited by the terms.

In addition, it should be understood that, when a first component is referred to as being “connected,” “coupled,” or “linked” to a second component, such a description may include both a case in which the first component is directly connected, coupled, or linked to the second component, and a case in which the first component is connected or coupled to the second component with a third component interposed therebetween.

In addition, when a first component is described as being formed or disposed “on (above)” or “under (below)” a second component, such a description includes both a case in which the two components are formed or disposed in direct contact with each other and a case in which one or more other components are interposed between the two components. In addition, when the first component is described as being formed “on (above) or under (below)” the second component, such a description may include a case in which the first component is formed at an upper side or a lower side with respect to the second component.

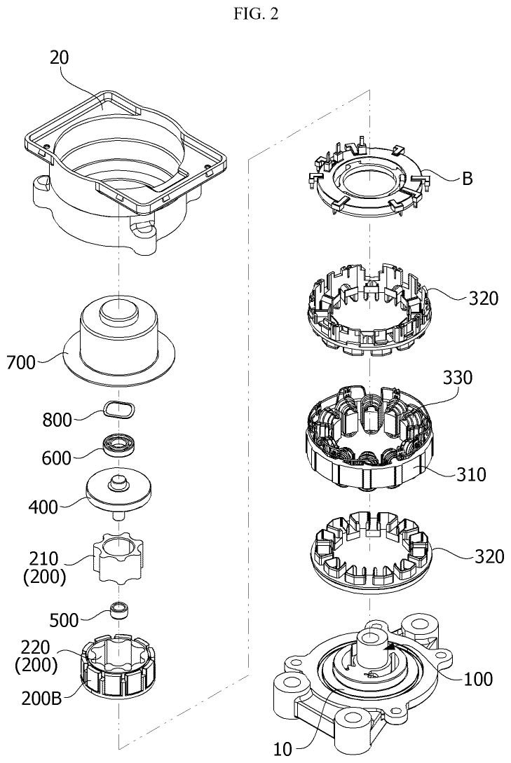

An “axial direction” to be used below is defined as a direction in which a rotation center of a rotor, an inner gear, and an outer gear is formed. The “axial direction” may be a direction in which exploded components of FIG. 2 are coupled. The “axial direction” may be defined as a vertical direction.

A “radial direction” to be used below is defined as a direction perpendicular to the “axial direction.” The “radial direction” may be defined as a protruding direction of a lobe from an inner surface of the outer gear and a protruding direction of the lobe from an inner surface of the inner gear.

A “circumferential direction” to be used below may be defined as a circumferential direction of any one of a stator, the rotor, the outer gear, and the inner gear or a circumferential direction of a region virtually concentrically formed in the circumferential direction of any one of the stator, the rotor, the outer gear, and the inner gear.

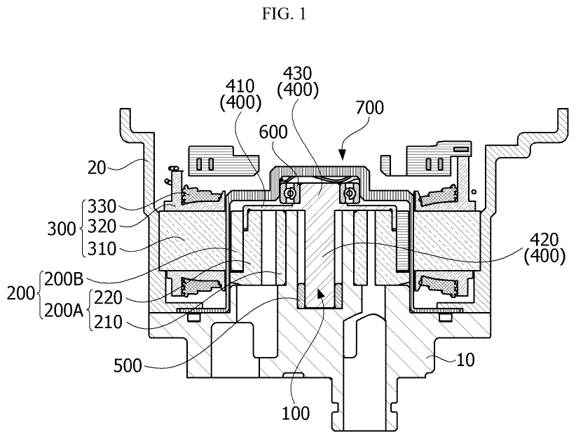

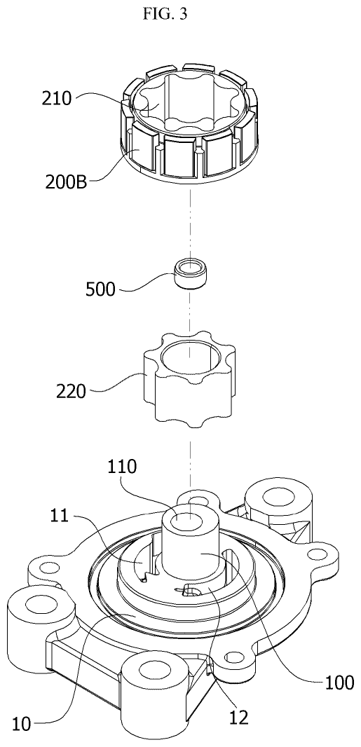

FIG. 1 is a cross-sectional view illustrating a pump according to an embodiment, FIG. 2 is an exploded view illustrating the pump illustrated in FIG. 1, and FIG. 3 is a view illustrating an outer gear, an inner gear, and a cover illustrated in FIG. 1.

Referring to FIGS. 1 to 3, a housing 20 is coupled to a cover 10. A motor is disposed in an inner space formed by the cover 10 and the housing 20. The cover 10 and the housing 20 may be coupled through a separate fastening member.

The cover 10 may include an inlet 11 and an outlet 12 formed in a surface facing an outer gear 210 and an inner gear 220 in an axial direction. A fluid is introduced into the rotor 200 through the inlet 11, and the fluid in the rotor 200 is discharged through the outlet 12.

A shaft 100 may include a hole 110. The hole 110 is disposed to extend in the axial direction. The hole 110 is a hole into which a first column 420 of a plate 400 is inserted.

The motor includes a rotor 200 and a stator 300. The stator 300 may be disposed outside a can 700, and the rotor 200 may be disposed inside the can 700. The can 700 may be a cylindrical member of which one side is open. The can 700 is coupled to the cover 10. An inner portion of the can 700 is a space in which the fluid flows and is sealed. The inlet 11 and the outlet 12 of the cover 10 and the shaft 100 are disposed in the can 700.

The rotor 200 may include a rotor core 200A and a magnet 200B. The magnet 200B may be disposed on an outer surface of the rotor core 200A. A plurality of magnets 200B may be disposed along a circumference of the rotor core 200A. In this case, the rotor core 200A may be divided into the outer gear 210 and the inner gear 220. The inner gear 220 is rotatably coupled to the shaft 100. The outer gear 210 is disposed outside the inner gear 220.

The stator 300 is disposed outside the can 700. In addition, the stator 300 is fixed to the housing 20. The stator 300 may include a stator core 310, an insulator 320 mounted on the stator core 310, and a coil 330. The coil 330 may be wound around the insulator 320. The insulator 320 is disposed between the coil 330 and the stator core 310 and serves to electrically insulate the stator core 310 from the coil 330. The coil 330 induces an electric interaction with the magnet 200B of the rotor 200.

A busbar B may be provided at one side of the stator 300. The busbar B is connected to the coil 330.

The plate 400 is disposed in the can 700 and disposed at one side of the rotor 200. The plate 400 is coupled to the outer gear 210. In addition, the plate 400 is rotatably coupled to the shaft 100. As the plate 400 rotates, the outer gear 210 rotates in conjunction with the rotation.

A first bearing 500 is disposed on the shaft 100 and rotatably supports the first column 420 of the plate 400.

A second bearing 600 is disposed at one side of the rotor 200. The second bearing 600 is disposed between the can 700 and a second column 430 of the plate 400 in a radial direction and rotatably supports the plate 400.

The inner gear 220 has a certain eccentric structure with respect to the outer gear 210 when the inner gear 220 rotates, and a space through which the fluid is transferred is formed between the outer gear 210 and the inner gear 220 due to such eccentricity. That is, when the outer gear 210 rotates, a pressure of a portion, of which a volume increases, is decreased so that the portion absorbs the fluid therearound, and a pressure of a portion, of which a volume decreases, is increased so that the portion discharges the fluid.

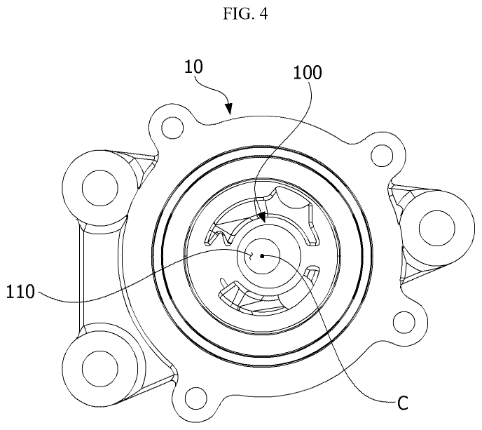

FIG. 4 is a plan view illustrating the cover 10 and a shaft 100.

Referring to FIG. 4, the shaft 100 includes the hole 110 therein. The hole 110 is eccentrically disposed at a center C of the shaft 100. This is to generate the space, through which the fluid may be transferred, between the outer gear 210 and the inner gear 220.

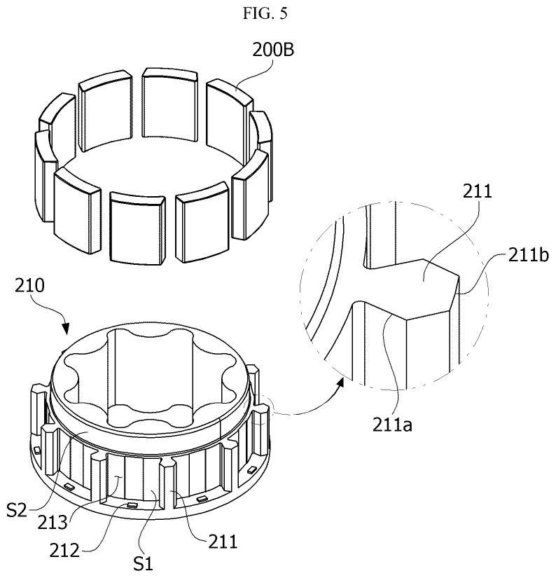

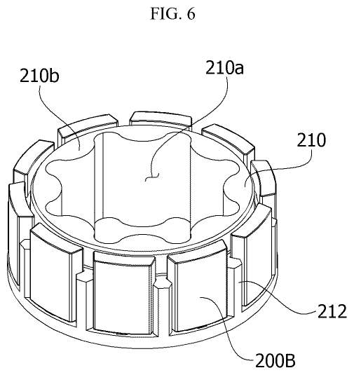

FIG. 5 is an exploded view illustrating the outer gear 210 and the magnet 200B. FIG. 6 is a perspective view illustrating the outer gear 210 and the magnet 200B.

Referring to FIGS. 5 and 6, in the outer gear 210, N outer lobes facing inward in the radial direction may be formed in a circumferential direction. In addition, the outer gear 210 may include a groove 213 accommodating the magnet 200B in an outer surface. A plurality of grooves 213 are disposed along a circumference of the outer surface of the outer gear 210. A Guide 211 is disposed between the grooves 213 in the circumferential direction. The guide 211 may be formed to protrude from the outer surface of the outer gear 210 in the radial direction and may extend in the axial direction.

A side surface 211a of the guide 211 faces a side surface of the magnet 200B disposed in the groove 213. A cross-sectional shape of the guide 211 may be a polygonal shape. An outer surface 211b of the guide 211 may be a flat or curved surface. When the outer surface 211b of the guide 211 is the curved surface, a curvature of the outer surface of the guide 211 may be the same as a curvature of the outer surface 211b of the outer gear 210. In addition, the outer surface 211b of the guide 211 may be formed to be connected to the outer surface of the outer gear 210 without a step. The outer gear 210 may include a protrusion 214 in contact with one surface of the magnet 200B in the axial direction. The protrusion 214 may be disposed on an inner wall of the groove 213.

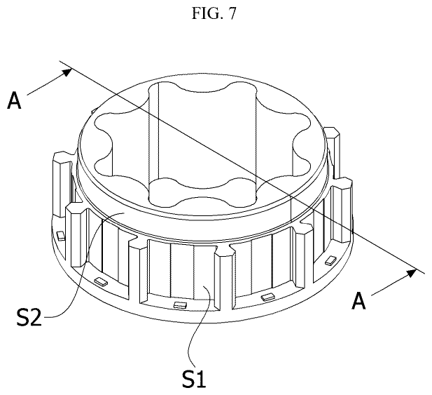

FIG. 7 is a perspective view illustrating the outer gear 210 including a first surface S1 and a second surface S2, and

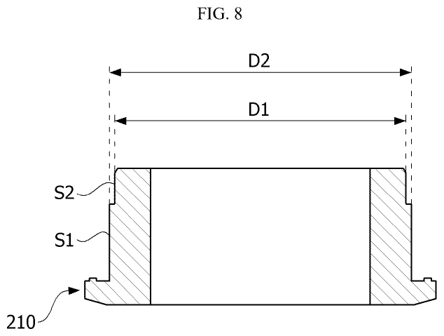

FIG. 8 is a transversal sectional view illustrating the outer gear along line A-A of FIG. 7.

Referring to FIGS. 7 and 8, the outer surface outer gear may include the first surface S1 and the second surface S2. The first surface S1 corresponds to the outer surface of the outer gear 210 in contact with the magnet 200B. The second surface S2 corresponds to the outer surface of the outer gear 210 spaced apart from the magnet 200B. The second surface S2 is disposed close to an end portion of the outer gear 210. The first surface S1 and the second surface S2 are disposed to be stepped.

In the outer gear 210, an outer diameter of a region in which the second surface S2 is formed may be smaller than an outer diameter of a region in which the first surface S1 is formed.

The second surface S2 is a surface in contact with the plate 400, that is, a surface into which a side portion 431 of the plate 400 is press fitted.

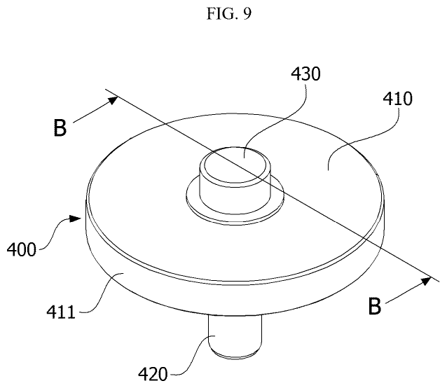

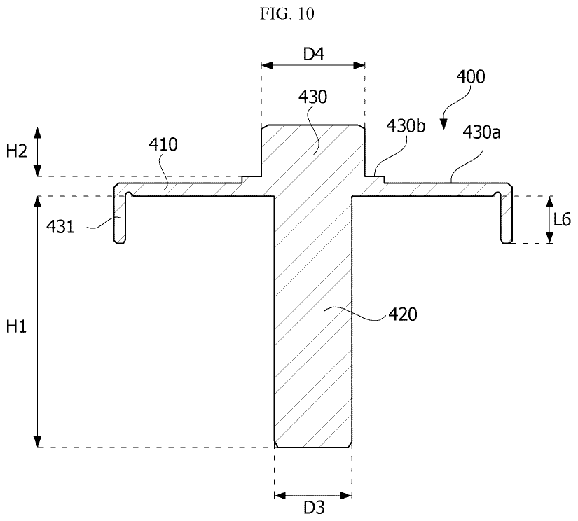

FIG. 9 is a perspective view illustrating the plate 400, and FIG. 10 is a transversal sectional view illustrating the plate 400 along line B-B of FIG. 9.

Referring to FIGS. 9 and 10, the plate 400 may include a body 410, the first column 420, and the second column 430.

The body 410 is disposed at one side of the rotor 200. The body 410 may be a disc member. The body 410 may include the side portion 431. The side portion 431 may be formed to be vertically bent from an edge of the body 410 in the axial direction. The side portion 431 may be disposed along a circumference of the body 410. The side portion 431 is a portion in contact with the second surface S2 of the outer gear 210.

The first column 420 protrudes from one side of the body 410 in the axial direction. The first column 420 may be disposed on a central portion of the body 410. The first column 420 is a cylindrical member. The first column 420 is disposed in the hole 110 and serves as a rotary shaft of the outer gear 210. The first column 420 is rotatably supported by the first bearing 500.

The second column 430 protrudes form the other side of the body 410 in the axial direction. The second column 430 may also be disposed on the central portion of the body 410. The second column 430 is a cylindrical member. The second column 430 is disposed outside the hole 110. The second column 430 is rotatably supported by the second bearing 600.

Meanwhile, the other surface 430a of the body 410 may include a seating surface 430b on which the second bearing 600 is seated. The seating surface 430b may be disposed close to the second column 430 and may protrude further than the other surface 430a of the body 410.

In addition, an outer diameter D3 of the first column 420 may be smaller than an outer diameter D4 of the second column 430. The outer diameter D3 of the first column 420 disposed in the shaft 100 is smaller than the outer diameter D4 of the second column 430 disposed outside the shaft 100. In addition, a length H1 of the second column 430 in the axial direction may be smaller than a length H2 of the first column 420 in the axial direction.

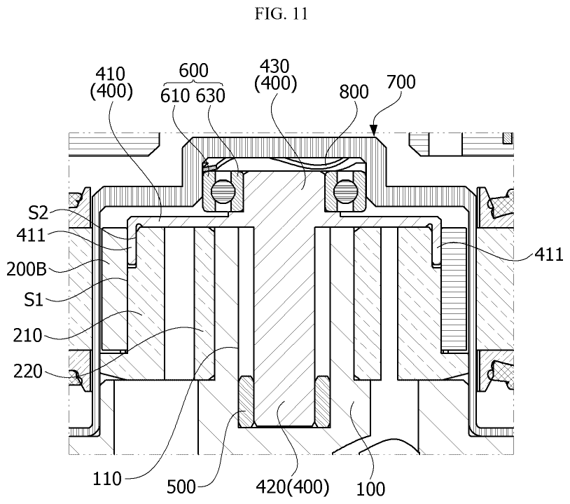

FIGS. 11 to 13 are enlarged transversal sectional views illustrating the pump.

Referring to FIG. 11, the hole 110 is disposed in the shaft 100, and the first column 420 is disposed in the hole 110. The first bearing 500 is disposed in the hole 110 and rotatably supports the first column 420.

The second bearing 600 is coupled to the second column 430. An inner wheel 620 of the second bearing 600 is in contact with the second column 430, and an outer wheel 610 of the second bearing 600 is in contact with an inner wall of the can 700.

The first bearing 500 may include a region which does not overlap the outer gear 210 and the inner gear 220 in the radial direction. That is, the first bearing 500 may be disposed to protrude further than the outer gear 210 and the inner gear 220 in the axial direction.

As described above, the first bearing 500 and the second bearing 600 respectively rotatably support the first column 420 and the second column 430 which become a shaft of the outer gear 210. That is, since the first bearing 500 and the second bearing 600 support both end portions which become a shaft of the outer gear 210, the outer gear 210 can be inhibited from tilting with respect to the axial direction due to tolerances of the first bearing 500 and the second bearing 600. In the case of the pump according to the embodiment, since the outer gear 210 does not tilt with respect to the axial direction, there are advantages that the rotational stability of the rotor 200 is improved, and a torque loss caused by contact between the outer gear 210 the can 700 does not occur.

Meanwhile, an elastic member 800 such as a washer is disposed between the can 700 and the second bearing 600 in the axial direction. The elastic member 800 is in contact with the outer wheel 610 of the second bearing 600 to press the second bearing 600 in the axial direction. Since the second bearing 600 is pressed in advance in the axial direction, a tolerance of the second bearing 600 in the axial direction may be removed. Since the pressure is applied to the second bearing 600 in advance through the elastic member 800, the outer gear 210 is inhibited from tilting due to the tolerance of the second bearing 600 with respect to the axial direction.

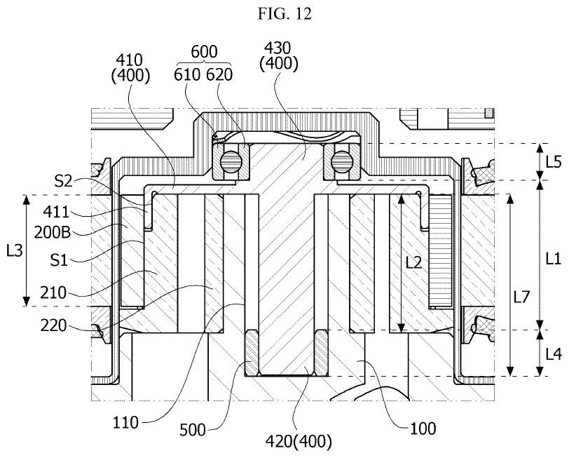

Referring to FIG. 12, a length L1 between the first bearing 500 and the second bearing 600 in the axial direction may be greater than a length L2 of the rotor core 200A in the axial direction and smaller than or equal to the sum of a length L2 of the rotor core 200A in the axial direction and half of the sum of a length L4 of the first bearing 500 in the axial direction and a length L5 of the second bearing 600 in the axial direction.

Meanwhile, an inner surface of the side portion 431 is in contact with the second surface S2. An outer surface of the side portion 431 may be in contact with an inner surface magnet 200B. As the side portion 431 is coupled to the outer gear 210, the plate 400 and the outer gear 210 rotate together. The side portion 431 is disposed to overlap the magnet 200B and the outer gear 210 in the radial direction.

Meanwhile, a length L6 (see FIG. 10) of the side portion 431 in the axial direction may be smaller than the length L1 of the magnet 200B in the axial direction.

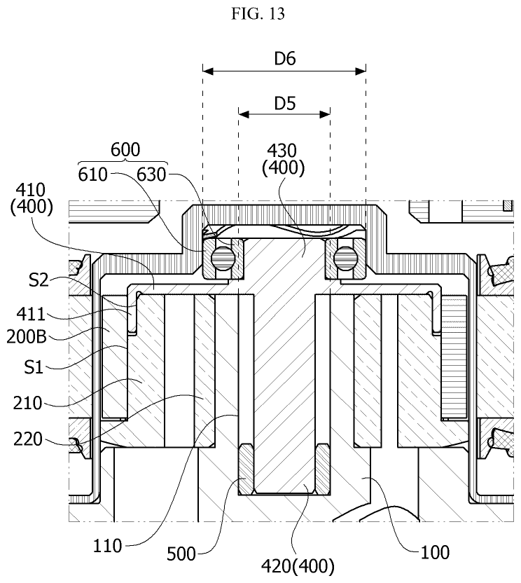

A length L7 of the hole 110 in the axial direction is greater than a length L2 of the outer gear 210 in the axial direction and a length L2 of the inner gear 220 in the axial direction. This is to secure a mounting space of the first bearing 500 and the sufficient length of the first column 420 in order to support the outer gear 210 from the outside of the outer gear 210 in the axial direction. In addition, as illustrated in FIG. 13, an inner diameter D5 of the hole 110 may be smaller than an outer diameter D6 of the second bearing 600.

As described above, since the hole 110 of the shaft 100 is used, and the first bearing 500 may be mounted inside the hole 110, both one side and the other side of the rotor 200 may be rotatably supported in a limited space, and thus the rotational stability of the rotor 200 can be further improved.

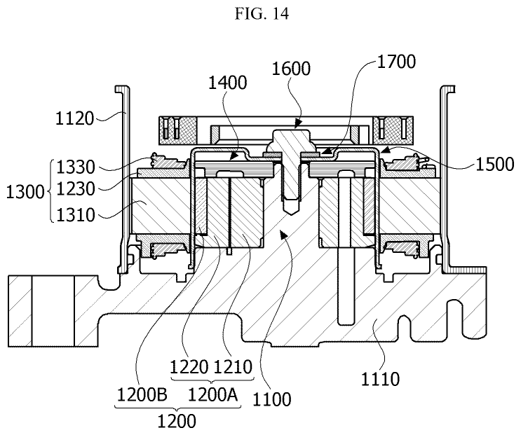

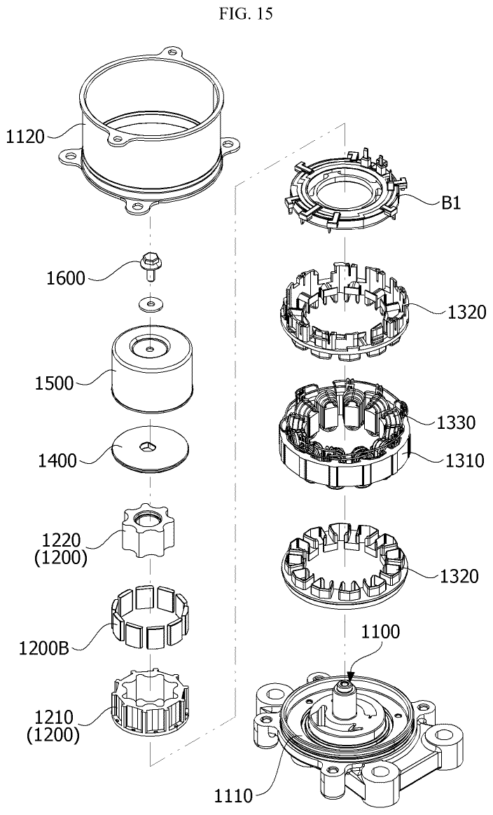

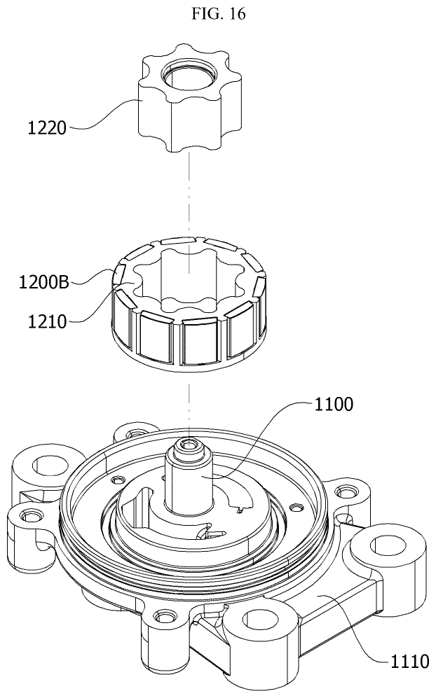

FIG. 14 is a cross-sectional view illustrating a pump according to an embodiment, FIG. 15 is an exploded view illustrating the pump illustrated in FIG. 14, and FIG. 16 is a view illustrating an outer gear, an inner gear, and a cover illustrated in FIG. 14.

Referring to FIGS. 14 to 16, a housing 1120 is coupled to a cover 1110. A motor is disposed in an inner space formed by the cover 1110 and the housing 1120. The cover 1110 and the housing 1120 may be coupled through a separate fastening member.

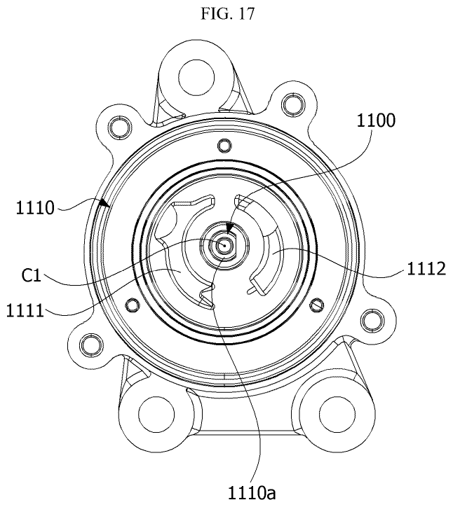

The cover 1110 may include an inlet 1111 (see FIG. 17) and an outlet 1112 (see FIG. 17) formed in a surface facing an outer gear 1210 and an inner gear 1220 in an axial direction. A fluid is introduced into the rotor 1200 through the inlet 1111, and the fluid in the rotor 1200 is discharged through the outlet 1112.

A shaft 1100 is disposed on the cover 1110. The shaft 1100 may be integrated with the cover 1110.

The motor includes the rotor 1200 and a stator 1300. The stator 1300 may be disposed outside a can 1500, and the rotor 1200 may be disposed inside the can 1500. The can 1500 may be a cylindrical member of which one side is open. The can 1500 is coupled to the cover 1110. An inner portion of the can 1500 is a space in which the fluid flows and is sealed. The inlet 1111 and the outlet 1112 of the cover 1110 and the shaft 1100 are disposed in the can 1500.

The rotor 1200 may include a rotor core 1200A and a magnet 1200B. The magnet 1200B may be disposed on an outer surface of the rotor core 1200A. A plurality of magnets 1200B may be disposed along a circumference of the rotor core 1200A. In this case, the rotor core 1200A may be divided into the outer gear 1210 and the inner gear 1220. The inner gear 1220 is rotatably coupled to the shaft 1100. The outer gear 1210 is disposed outside the inner gear 1220.

The stator 1300 is disposed outside the can 1500. In addition, the stator 1300 is fixed to the housing 1120. The stator 1300 may include a stator core 1310, an insulator 1320 mounted on the stator core 1310, and a coil 1330. The coil 1330 may be wound around the insulator 1320. The insulator 1320 is disposed between the coil 1330 and the stator core 1310 and serves to electrically insulate the stator core 1310 from the coil 1330. The coil 1330 induces an electric interaction with the magnet 1200B of the rotor 1200.

A busbar B may be provided at one side of the stator 1300. The busbar B is connected to the coil 1330.

A plate 1400 is disposed in the can 1500 and disposed at one side of the rotor 1200. The plate 1400 is coupled to the shaft 1100.

The inner gear 1220 has a certain eccentric structure with respect to the outer gear 1210 when the inner gear 1220 rotates, and a space through which the fluid is transferred is formed between the outer gear 1210 and the inner gear 1220 due to such eccentricity. That is, when the outer gear 1210 rotates, a pressure of a portion, of which a volume increases, is decreased so that the portion absorbs the fluid therearound, and a pressure of a portion, of which a volume decreases, is increased so that the portion discharges the fluid.

FIG. 17 is a plan view illustrating the cover 1110 and a shaft 1100.

Referring to FIG. 17, the shaft 1100 includes a hole 1110 therein. The hole 1110 is disposed at a center C1 of the shaft 1100. The inlet 1111 and the outlet 1112 are disposed around the shaft 1100.

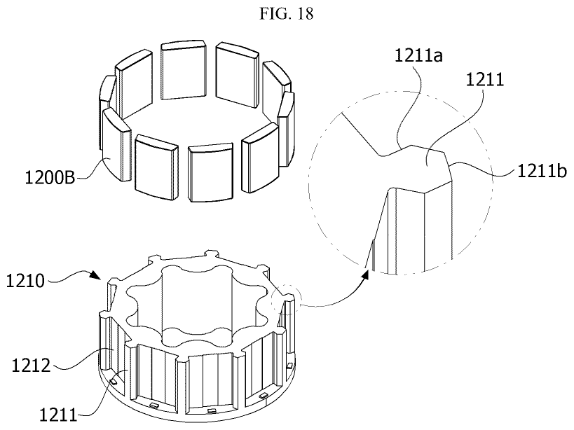

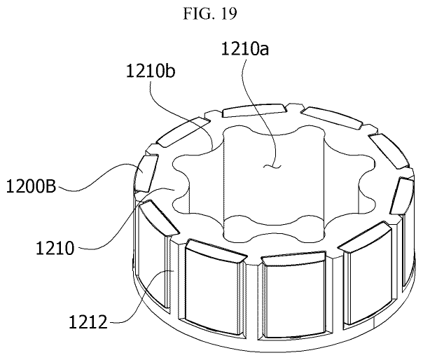

FIG. 18 is an exploded view illustrating the outer gear 1210 and a magnet 1200B, and FIG. 19 is a perspective view illustrating the outer gear 1210 and the magnet 1200B.

Referring to FIGS. 18 and 19, in the outer gear 1210, N outer lobes facing inward in a radial direction may be formed in a circumferential direction. In addition, the outer gear 1210 may include a groove 1212 accommodating the magnet 1200B in an outer surface. A plurality of grooves 1212 are disposed along a circumference of the outer surface of the outer gear 1210. A guide 1211 is disposed between the grooves 1212 in the circumferential direction. The guide 1211 may be formed to protrude from the outer surface of the outer gear 1210 in the radial direction and may extend in the axial direction.

A side surface 1211a of the guide 1211 faces a side surface of the magnet 1200B disposed in the groove 1212. A cross-sectional shape of the guide 1211 may be a polygonal shape. An outer surface 1211b of the guide 1211 may be a flat or curved surface.

Referring to FIG. 19, in the outer gear 1210, the N outer lobes facing inward in the radial direction may be formed in the circumferential direction. In addition, the outer gear 1210 formed a space 1210a in which the inner gear 1220 is located.

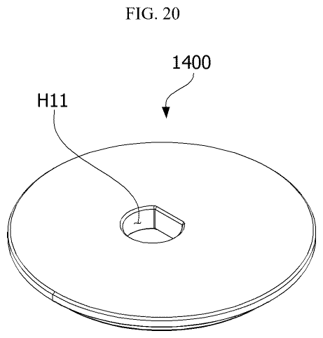

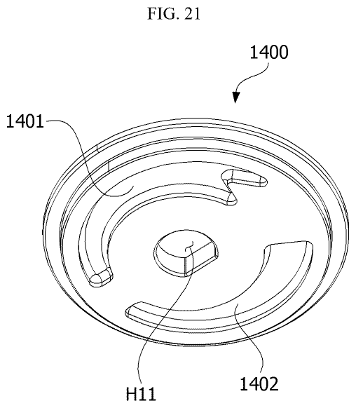

FIG. 20 is a perspective view illustrating the plate 1400, and FIG. 21 is a bottom view illustrating the plate 1400.

Referring to FIGS. 20 and 21, the plate 1400 is coupled to the shaft 1100 and covers the rotor 1200 in the axial direction. A first hole H11 is disposed at a location which is eccentric with respect to a center of the plate 1400.

The plate 1400 may include a first flow path 1401 and a second flow path 1402 concavely formed in a surface facing the outer gear 1210 and the inner gear 1220 in the axial direction. The first flow path 1401 is disposed to correspond to the inlet 1111. The second flow path 1402 is disposed to correspond to the outlet 1112.

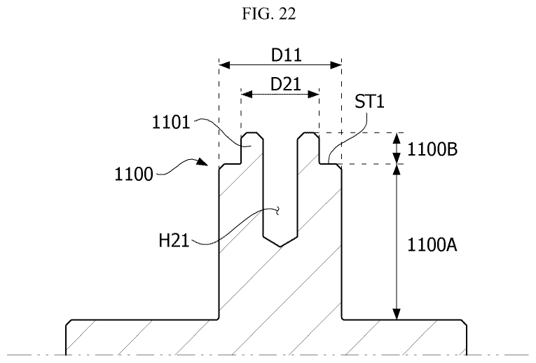

FIG. 22 is a transversal sectional view illustrating the shaft 1100.

Referring to FIG. 22, the shaft 1100 may include a first part 1100A and a second part 1100B. the first part 1100A has a first outer diameter D11, and the second part 1100B extends from the first part 1100A and has a second outer diameter D21 smaller than the first outer diameter D11.

A stepped surface ST1 is disposed at a boundary between the first part 1100A and the second part 1100B. The other surface of the plate 1400 is seated on the stepped surface ST1. In addition, the second part 1100B is located in the first hole of the plate 1400.

Meanwhile, the shaft 1100 include a second hole H21 to which a fastening member 1600 is fastened. The second hole H21 is disposed from the first part 1100A to the second part 1100B. A thread may be formed on an inner circumferential surface of the second hole H21 such that the fastening member 1600 may be fastened to the second hole H21 when rotating.

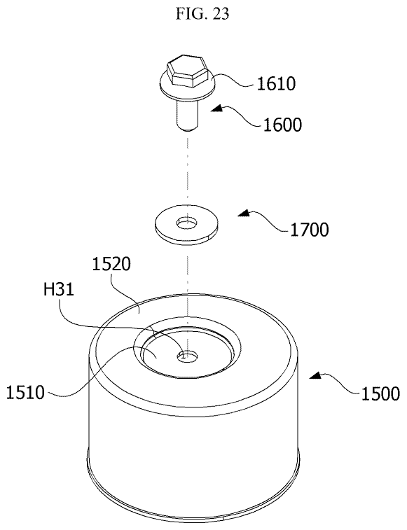

FIG. 23 is a view illustrating the can 1500 and a fastening member 1600.

Referring to FIG. 23, the can 1500 includes a third hole H31 at a center. The third hole H31 is formed to pass through one surface and the other surface of the can 1500. In addition, the can 1500 may include an inner side portion 1510 and an outer side portion 1520. The inner side portion 1510 is disposed along a circumference of the third hole H31. The outer side portion 1520 may be disposed outside the inner side portion 1510 in the radial direction. The inner side portion 1510 and the outer side portion 1520 are disposed to be stepped.

The fastening member 1600 may be a rotational fastening member 1600 such as a bolt. The fastening member 1600 is inserted into the third hole H31 such that a head 1610 of the fastening member 1600 comes into contact with the inner side portion 1510. An annular sealing member 1700 may be disposed between the fastening member 1600 and the inner side portion 1510. The sealing member 1700 is compressed by the head 1610 of the fastening member 1600 in a process in which the fastening member 1600 is fastened thereto to inhibit a hydraulic oil from leaking through the third hole H31 or foreign mass from being introduced into the can 1500.

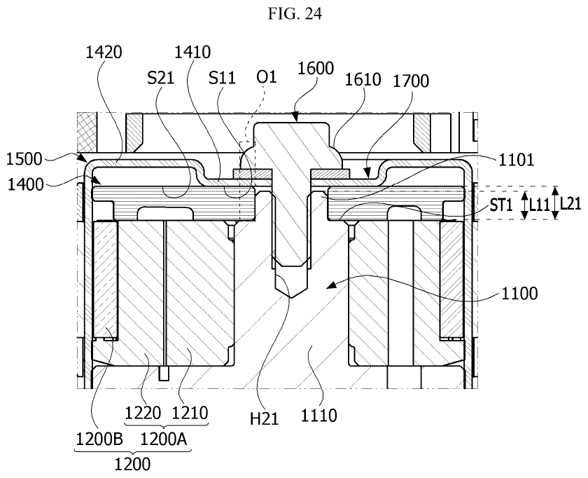

FIG. 24 is a transversal sectional view illustrating the pump.

Referring to FIG. 24, the fastening member 1600 fixes both the inner side portion 1510 of the can 1500 and the plate 1400 to the shaft 1100.

In this case, as illustrated in portion O of FIG. 24, the head 1610 of the fastening member 1600 is disposed to overlap the can 1500 and the plate 1400 in the axial direction.

The second part 1100B of the shaft 1100 is disposed in the first hole H11 of the plate 1400. Accordingly, the second part 1100B is disposed to overlap the plate 1400 in the radial direction.

The plate 1400 is seated on the stepped surface ST1 of the shaft 1100. The fastening member 1600 presses the plate 1400 while fastened to the second hole H21, and since the plate 1400 is seated on the stepped surface ST1, the plate 1400 may be supported against a pressing force of the fastening member 1600.

The inner side portion 1510 of the can 1500 is in contact with the plate 1400. In addition, the outer side portion 1520 of the can 1500 is disposed to be spaced apart from the plate 1400 in the axial direction.

The plate 1400 may include a first surface S11 and a second surface S21. The first surface S11 is a surface in contact with the can 1500, and the second surface S21 is a surface spaced apart from the can 1500 in the axial direction.

The inner side portion 1510 of the can 1500 is in contact with an upper portion of the plate 1400, the sealing member 1700 is in contact with an upper portion of the inner side portion 1510 of the can 1500, and the head 1610 of the fastening member 1600 is in contact with an upper portion of the sealing member 1700. In this state, when the fastening member 1600 is fastened to the second hole H21, the plate 1400 is pressed by the head 1610 of the fastening member 1600 with the can 1500 and directly fixed to the shaft 1100.

In this case, a length L11 of the second part 1100B in the axial direction may be smaller than a length L21 of the plate 1400 in the axial direction, so that the second part 1100B may be formed is not in contact with the can 1500.

In a state in which the fastening member 1600 is fastened to the shaft 1100, the fastening member 1600 may be disposed to overlap the can 1500, the plate 1400, and the rotor 1200 in the radial direction.

As described above, as the plate 1400 is directly fixed to the shaft 1100 with the can 1500 using the fastening member 1600 to inhibit the plate 1400 from tilting, a shaft system can be inhibited from tilting. In addition, since the fastening member 1600 directly fixes the plate 1400, the plate 1400 is inhibited from shaking or rotating, and thus there is an advantage that a tolerance between the rotor and the plate 1400 can be precisely managed.

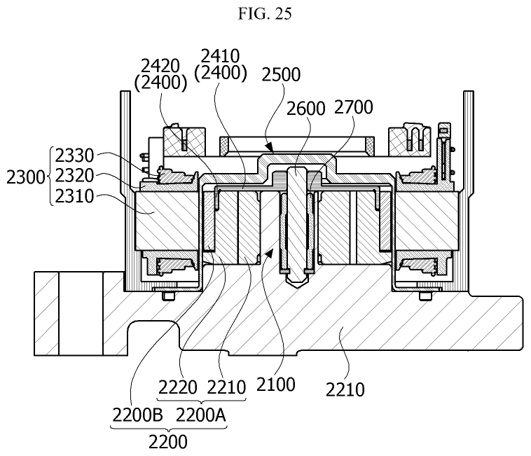

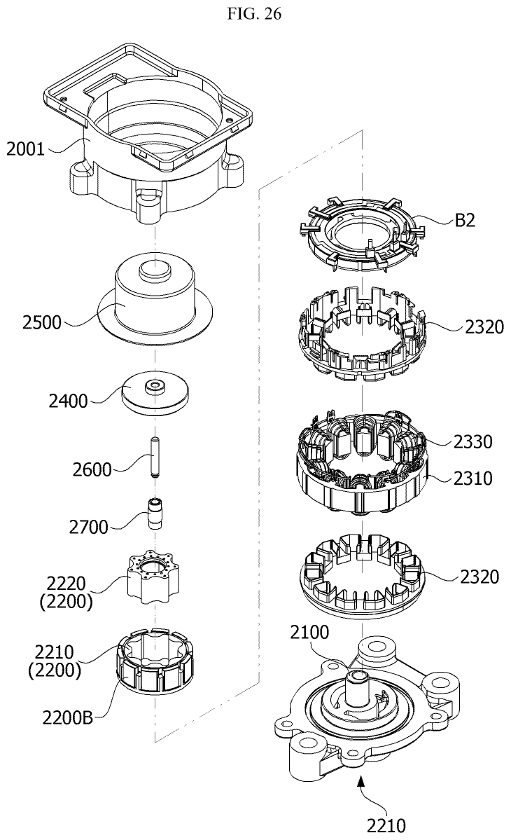

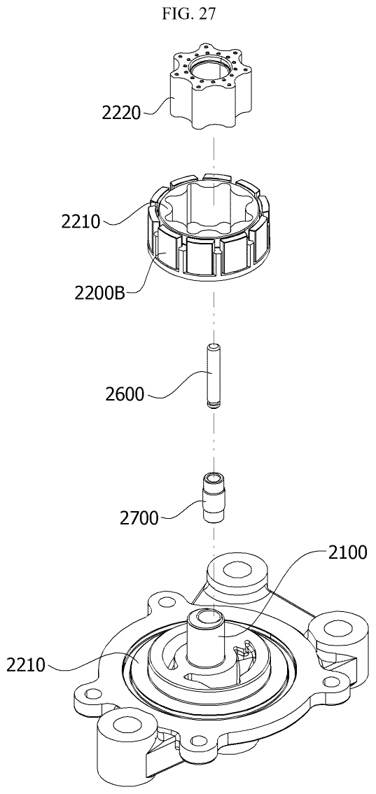

FIG. 25 is a cross-sectional view illustrating a pump according to an embodiment, FIG. 26 is an exploded view illustrating the pump illustrated in FIG. 25, and FIG. 27 is a view illustrating an outer gear, an inner gear, and a cover illustrated in FIG. 26.

Referring to FIGS. 25 to 27, a housing 2001 is coupled to a cover 2210. A motor is disposed in an inner space formed by the cover 2210 and the housing 2220. The cover 2210 and the housing 2001 may be coupled through a separate fastening member.

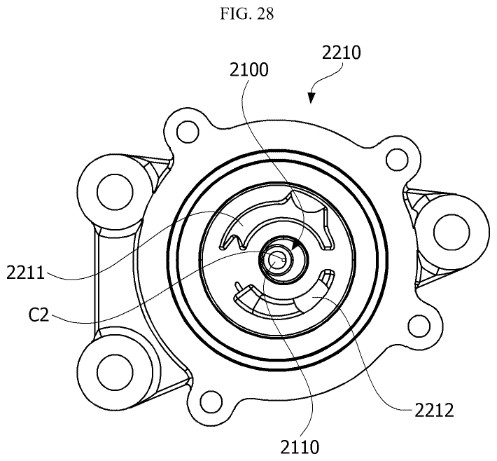

The cover 2210 may include an inlet 2211 (see FIG. 28) and an outlet 2212 (see FIG. 28) formed in a surface facing an outer gear 2210 and an inner gear 2220 in an axial direction. A fluid is introduced into the rotor 2200 through the inlet 2211, and the fluid in the rotor 2200 is discharged through the outlet 2212.

A shaft 2100 is disposed on the cover 2210. The shaft 2100 may be integrated with the cover 2210.

The motor includes the rotor 2200 and a stator 2300. The stator 2300 may be disposed outside a can 2500, and the rotor 2200 may be disposed inside the can 2500. The can 1500 may be a cylindrical member of which one side is open. The can 2500 is coupled to the cover 2210. An inner portion of the can 2500 is a space in which the fluid flows and is sealed. The inlet 2211 and the outlet 2212 of the cover 2210 and the shaft 2100 are disposed in the can 2500.

The rotor 2200 may include a rotor core 2200A and a magnet 2200B. The magnet 2200B may be disposed on an outer surface of the rotor core 2200A. A plurality of magnets 2200B may be disposed along a circumference of the rotor core 2200A. In this case, the rotor core 2200A may be divided into the outer gear 2210 and the inner gear 2220. The inner gear 2220 is rotatably coupled to the shaft 2100. The outer gear 2210 is disposed outside the inner gear 2220.

The stator 2300 is disposed outside the can 2500. In addition, the stator 2300 is fixed to the housing 2220. The stator 2300 may include a stator core 2310, an insulator 2320 mounted on the stator core 2310, and a coil 2330. The coil 2330 may be wound around the insulator 2320. The insulator 2320 is disposed between the coil 2330 and the stator core 2310 and serves to electrically insulate the stator core 2310 from the coil 2330. The coil 2330 induces an electric interaction with the magnet 2200B of the rotor 2200.

A busbar B2 may be provided at one side of the stator 2300. The busbar B2 is connected to the coil 2330.

A plate 2400 is disposed in the can 2500 and disposed at one side of the rotor 2200. The plate 2400 is coupled to the outer gear 2210. In addition, the plate 2400 is rotatably coupled to the shaft 2100. As the plate 2400 rotates, the outer gear 2210 rotates in conjunction with the rotation.

A second shaft 2600 is coupled to a center of the plate 2400. In addition, the second shaft 2600 may be disposed in a first shaft 2100.

A bearing 2700 is disposed on the first shaft 2100. The bearing 2700 rotatably supports the second shaft 2600.

The inner gear 2220 has a certain eccentric structure with respect to the outer gear 2210 when the inner gear 2220 rotates, and a space through which the fluid is transferred is formed between the outer gear 2210 and the inner gear 2220 due to such eccentricity. That is, when the outer gear 2210 rotates, a pressure of a portion, of which a volume increases, is decreased so that the portion absorbs the fluid therearound, and a pressure of a portion, of which a volume decreases, is increased so that the portion discharges the fluid.

FIG. 28 is a plan view illustrating the cover 2210 and the shaft 2100.

Referring to FIG. 28, the shaft 2100 includes a first hole 2110 therein. The first hole 2110 is eccentrically disposed at a center C2 of the shaft 2100. This is to generate a space, through which the fluid may be transferred, between the outer gear 2210 and the inner gear 2220.

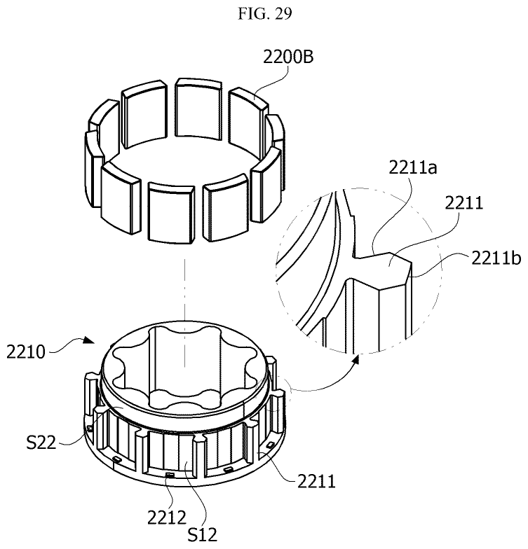

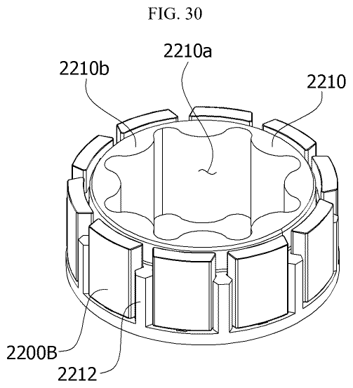

FIG. 29 is an exploded view illustrating the outer gear 2210 and the magnet 2200B, and FIG. 30 is a perspective view illustrating the outer gear 2210 and the magnet 2200B.

Referring to FIGS. 29 and 30, in the outer gear 2210, N lobes 2210b facing inward in a radial direction may be formed in a circumferential direction. In addition, a space 210a in which the inner gear 2220 is located is formed in the outer gear 2210.

The outer gear 2210 may include a groove 2212 accommodating the magnet 2200B in an outer surface. A plurality of grooves 2212 are disposed along a circumference of the outer surface of the outer gear 2210. A guide 2211 is disposed between the grooves 2212 in the circumferential direction. The guide 2211 may be formed to protrude from the outer surface of the outer gear 2210 in the radial direction and may extend in the axial direction.

A side surface 2211a of the guide 2211 faces a side surface of the magnet 2200B disposed in the groove 2212. A cross-sectional shape of the guide 2211 may be a polygonal shape. An outer surface 2211b of the guide 2211 may be a flat or curved surface. When the outer surface 2211b of the guide 2211 is the curved surface, a curvature of the outer surface of the guide 2211 may be the same as a curvature of the outer surface 2211b of the outer gear 2210. In addition, the outer surface 2211b of the guide 2211 may be formed to be connected to the outer surface of the outer gear 2210 without a step.

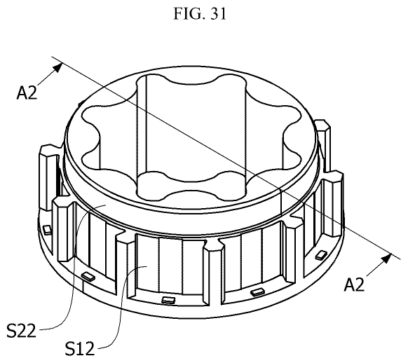

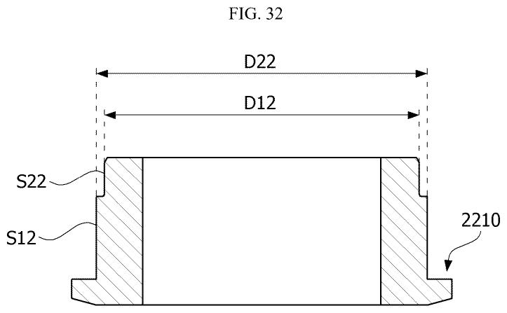

FIG. 31 is a perspective view illustrating the outer gear 2210 including a first surface S12 and a second surface S22, and FIG. 32 is a transversal sectional view illustrating the outer gear 2210 along line A-A of FIG. 31.

Referring to FIGS. 31 and 32, the outer surface of the outer gear may include the first surface S12 and the second surface S22. The first surface S12 corresponds to the outer surface of the outer gear 2210 in contact with the magnet 2200B. The second surface S22 corresponds to the outer surface of the outer gear 2210 disposed to be spaced apart from the magnet 2200B. The second surface S22 is disposed close to an end portion of the outer gear 2210. The first surface S12 and the second surface S22 are disposed to be stepped.

In the outer gear 2210, an outer diameter of a region in which the second surface S22 is formed may be smaller than an outer diameter of a region in which the first surface S12 is formed.

The second surface S22 is a surface in contact with the plate 2400, that is, a surface into which a side portion 2431 of the plate 2400 is press fitted.

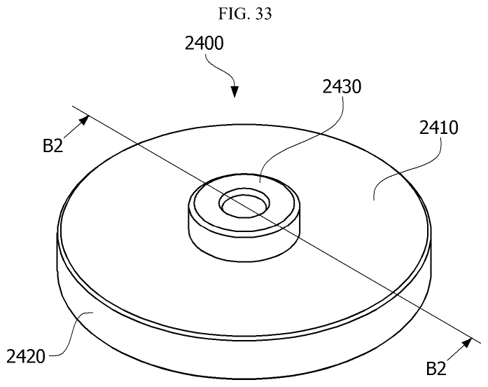

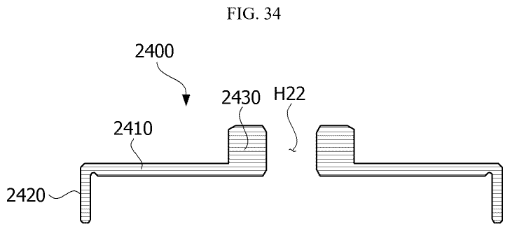

FIG. 33 is a perspective view illustrating the plate 2400, and FIG. 34 is a transversal sectional view illustrating the plate 2400 along line B-B of FIG. 33.

Referring to FIGS. 33 and 34, The plate 2400 may include a body 2410, a side portion 2420, and a column 2430.

The body 2410 is disposed at one side of the rotor 2200. The body 2410 may be a disc member. The body 2410 may include the side portion 2420. The side portion 2420 may be formed to be vertically bent from an edge of the body 2410 in the axial direction. The side portion 2420 may be disposed along a circumference of the body 2410. The side portion 2420 is a portion in contact with the second surface S22 of the outer gear 2210.

The column 2430 protrudes from one side of the body 2410 in the axial direction. The column 2430 may be disposed on a central portion of the body 2410. A second hole H22 through which the second shaft 2600 passes may be disposed in the column 2430. A sufficient length of the second hole H22 capable of supporting an end portion of the second shaft 2600 may be secured using the column 2430.

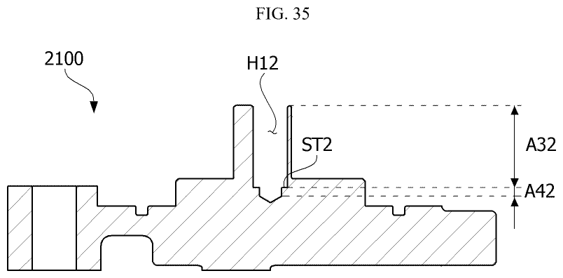

FIG. 35 is a transversal sectional view illustrating the first shaft 2100.

Referring to FIG. 35, a first hole H12 of the first shaft 2100 may include a third region A32 and a fourth region A42. A stepped surface ST2 is disposed at a boundary between the third region A32 and the fourth region A42 in the axial direction. A snap ring 2800 is seated on the stepped surface ST2.

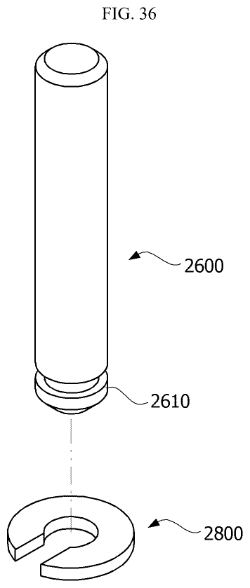

FIG. 36 is a view illustrating the second shaft 2600 and the snap ring 2800.

Referring to FIG. 36, the second shaft 2600 may have a cylindrical shape. The second shaft 2600 may include a groove 2610 disposed in an outer surface. The groove 2610 is disposed along a circumference of the of the second shaft 2600. The snap ring 2800 is inserted in to the groove 2610 of the second shaft 2600. The snap ring 2800 is seated on the stepped surface ST2 of the first hole H12 and serves to restrict the second shaft 2600 to inhibit the second shaft 2600 from being withdrawn in the axial direction.

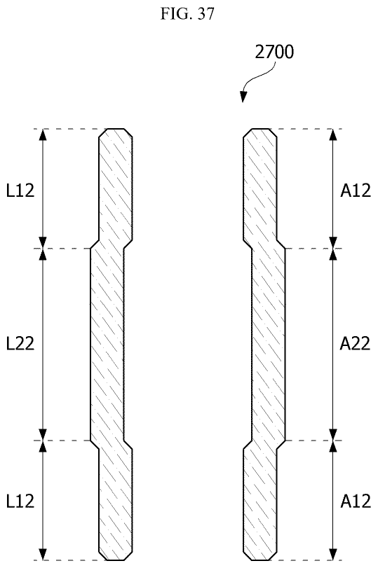

FIG. 37 is a transversal sectional view illustrating the bearing 2700.

Referring to FIG. 37, the bearing 2700 may be a bearing 2700 of which a bearing surface and a journal are in surface contact with each other. The bearing 2700 may be divided into first regions A12 and a second region A22. The first region A12 is defined as a region of which an inner surface is in contact with the outer surface of the second shaft 2600 and an outer surface is disposed to be spaced apart from an inner surface of the first shaft 2100. In addition, the second region A22 is defined as a region of which an inner surface is disposed to be spaced apart from the outer surface of the second shaft 2600 and an outer surface is in contact with the inner surface of the first shaft 2100.

The second region A22 may be disposed in a central portion of the bearing 2700 in the axial direction. The first region A12 may be disposed at each of one side and the other side of the second region A22 in the axial direction. An outer diameter of the second region A22 is greater than an outer diameter of the first region A12. The first region A12 is to rotatably support the second shaft 2600, and the second region A22 is to fix the bearing 2700 to the first shaft 2100.

A length L12 of the first region A12 in the axial direction may be smaller than a length L22 of the second region A22 in the axial direction.

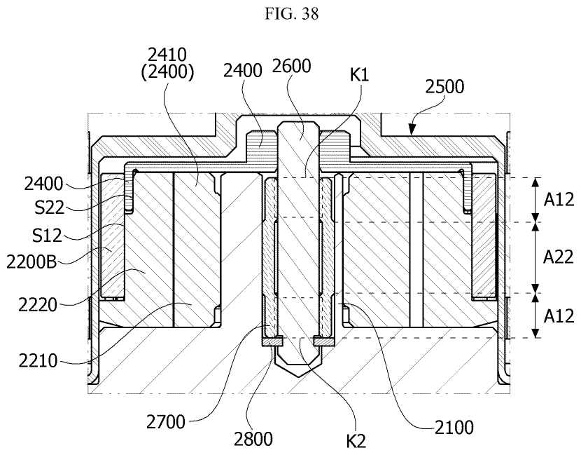

FIG. 38 is a transversal sectional view illustrating the rotor 2200.

Referring to FIGS. 35 and 38, the fourth region A42 of the first hole H12 of the first shaft 2100 may be disposed at the other side of the rotor 2200 in the axial direction not to overlap the rotor 2200 in the radial direction. In addition, the snap ring 2800 may also be disposed at the other side of the rotor 2200 in the axial direction not to overlap the rotor 2200 in the radial direction.

Meanwhile, an inner surface of the side portion 2431 is in contact with the second surface S22. An outer surface of the side portion 2431 may be in contact with an inner surface of the magnet 2200B. The first surface S12 of the outer gear 2210 is in contact with the inner surface of the magnet 220B. As the side portion 2431 is coupled to the outer gear 2210, the plate 2400 and the outer gear 2210 rotate together. The side portion 2431 is disposed to overlap the magnet 2200B and the outer gear 2210 in the radial direction.

Referring to FIG. 38, in a state in which the bearing 2700 is disposed in the first shaft 2100, the second region A22 of the bearing 2700 is press-fitted into an inner circumferential surface of the first shaft 2100. An outer surface of the first region A12 is spaced apart from the inner circumferential surface of the first shaft 2100. Since the first region A12 is disposed on both end portions of the bearing 2700, an entrance space through which the bearing 2700 enters the first shaft 2100 is secured when the bearing 2700 is press-fitted into the first shaft 2100, and thus the bearing 2700 may be more easily press-fitted thereinto.

One of two first regions A12 is disposed at one side of a center of the rotor 2200 in the axial direction, and the other of two first regions A12 is disposed at the other side of the center of the rotor 2200 in the axial direction. Accordingly, in a state in which the second region A22 disposed at the central portion of the bearing 2700 is spaced apart from the outer surface of the second shaft 2600, since the first region A12 supports only one end portion of the second shaft 2600 as illustrated in portion K1 of FIG. 38, and the second region A22 supports only the other end portion of the second shaft 2600 as illustrated in portion K2 of FIG. 38, contactability at both end portions of the second shaft 2600 is improved, and thus the second shaft 2600 can be effectively supported not to be tilted in a shaft system.

As described above, when the bearing 2700 directly supports the second shaft 2600 to inhibit the second shaft 2600 from tilting, the tilt of the shaft system which may occur due to a hydraulic pressure in the can can be effectively inhibited. In addition, friction generated by the outer gear coming into contact with the cap can be inhibited, thereby improving the efficiency of the pump.

While all components constituting embodiments of the invention have been described as being combined into one unit or being operated in a combined manner, the present invention is not necessarily limited thereto. That is, one or components may be selectively combined and operated within the scope of the invention. In addition, since the term “comprising,” “including,” “having,” or the like described above means that a corresponding component is present therein unless specifically described otherwise, it should be interpreted that another component is not excluded and may be further included. Unless otherwise defined, all terms including technical and scientific terms have meanings which are the same as meanings generally understood by those skilled in the art. Terms such as those defined in commonly used dictionaries should be interpreted as having meanings that are consistent with their meanings in the context of the relevant art and will not be interpreted in an idealized or overly formal sense unless explicitly defined in the present invention.

The above description is merely an illustrative description of the technical spirit of the present invention, and various changes and modifications may be made by those skilled in the art without departing from the essential characteristics of the present invention. Therefore, embodiments disclosed in the present invention are for only describing and not for limiting the spirit of the present invention, and the scope of the spirit of the present invention is not limited by the embodiments. the scope of the invention should be interpreted according to the appended claims, and interpreted to encompass all modifications and equivalents that fall within the scope of the appended claims.

The embodiments may be used in various devices for vehicles, home appliances, etc.

1. A motor comprising:
a shaft;
a rotor coupled to the shaft;
a stator disposed to correspond to the rotor;
a plate coupled to the rotor;
a first bearing and a second bearing which that support the plate; and
a can accommodating the rotor,
wherein the rotor includes a rotor core and a magnet disposed on the rotor core,
the shaft includes a hole,
the plate includes a body disposed at one side of the rotor, a first column protruding from the body toward one side in an axial direction and disposed in the hole and a second column protruding toward another side in the axial direction,
the first bearing is in contact with an inner wall of the hole and the first column, and
the second bearing is in contact with an inner wall of the can and the second column.

2. The motor of claim 1, wherein:
the body includes a side portion extending toward the rotor core; and
the side portion is in contact with the rotor.

3. The motor of claim 2, wherein:
the rotor includes the rotor core and the magnet disposed on the rotor core; and
a length between the first bearing and the second bearing in the axial direction is greater than a length of the rotor core of the rotor in the axial direction and smaller than or equal to a sum of the length of the rotor core in the axial direction and half of a sum of a length of the first bearing in the axial direction and a length of the second bearing in the axial direction.

4. A motor comprising:
a can;
a stator disposed outside the can;
an outer gear disposed in the can;
an inner gear disposed inside the outer gear;
a shaft disposed inside the inner gear;
a plate coupled to the shaft; and
a first bearing and a second bearing which that support the plate,
wherein the shaft includes a hole,
the plate includes a body disposed at one side of the outer gear, a first column protruding from the body toward one side in an axial direction and disposed in the hole, and a second column protruding toward another side in the axial direction,
the first bearing is in contact with an inner wall of the hole and the first column, and
the second bearing is in contact with an inner wall of the can and the second column.

5. A motor comprising:
a shaft;
a rotor coupled to the shaft;
a stator disposed to correspond to the rotor;
a plate coupled to the shaft;
a can accommodating the rotor; and
a fastening member passing through the can and fastened to the shaft,
wherein a head of the fastening member is disposed to overlap the can and the plate in an axial direction and fixes both the can and the plate to the shaft.

6. The motor of claim 5, wherein:
the shaft includes a first hole;
the shaft includes a first part having a first outer diameter and a second part which that extends from the first part and is smaller than the first outer diameter; and
the second part is disposed in the first hole.

7. A pump comprising:
a can;
a stator disposed outside the can;
an outer gear disposed in the can;
an inner gear disposed inside the outer gear;
a first shaft disposed inside the inner gear;
a second shaft disposed inside the first shaft;
a plate coupled to the second shaft; and
a fastening member passing through the can and fastened to the shaft,
wherein a head of the fastening member is disposed to overlap the can and the plate in an axial direction and fixes both the can and the plate to the shaft.

8. A motor comprising:
a first shaft;
a rotor coupled to the first shaft;
a stator disposed to correspond to the rotor;
a second shaft disposed in a first hole of the first shaft;
a plate coupled to the second shaft;
a bearing disposed in the first hole and coupled to the second shaft; and
a can accommodating the rotor,
wherein the bearing includes a first region of which an inner surface is in contact with an outer surface of the second shaft and an outer surface is disposed to be spaced apart from an inner surface of the first shaft, and a second region of which an inner surface is disposed to be spaced apart from the outer surface of the second shaft and an outer surface is in contact with the inner surface of the first shaft, and
the first region is disposed at each of one side and another side of the second region in an axial direction.

9. The motor of claim 8, wherein:
the second shaft includes a groove disposed in the outer surface and further includes a snap ring disposed in the first shaft; and
the snap ring is disposed in the groove.

10. A pump comprising:
a can;
a stator disposed outside the can;
an outer gear disposed in the can;
an inner gear disposed inside the outer gear;
a first shaft disposed inside the inner gear;
a second shaft disposed inside the first shaft;
a plate coupled to the second shaft; and
a bearing disposed in the first shaft and coupled to the second shaft,
wherein the bearing includes a first region of which an inner surface is in contact with an outer surface of the second shaft and an outer surface is disposed to be spaced apart from an inner surface of the first shaft, and a second region of which an inner surface is disposed to be spaced apart from the outer surface of the second shaft and an outer surface is in contact with the inner surface of the first shaft, and
the first region is disposed at each of one side and another side of the second region in an axial direction.
